(19) United States
(12) Patent Application Publication
(10) Pub. No.: US 2009/0311932 A1
(43) Pub. Date: Dec. 17, 2009

(54) STRUCTURAL INSULATED PANEL CONSTRUCTION FOR BUILDING STRUCTURES

(76) Inventor: John Hughes, Farmington Hills, MI (US)

Correspondence Address: STEVE M CLEMMONS, 33150 SCHOOLCRAFT, SUITE 207, LIVONIA, MI, 48150, US

(21) Appl. No.: 12/545,813

(22) Filed: Aug. 22, 2009

Related U.S. Application Data
(63) Continuation-in-part of application No. 11/286,307, filed on Nov. 22, 2005.

(51) Int. Cl. B32B 3/26; B32B 5/26; B29C 45/14

(52) U.S. Cl. 442/224; 428/304.4; 264/261

(57) ABSTRACT

A structural insulated laminated construction panel for building structures is described. The panel comprises a rigid core material layer of expanded polymeric material having opposed flat parallel surfaces. The expanded polymeric material is injected between spaced outer and inner skins. An outer skin is secured to one of the flat surfaces and an inner skin is secured to the other of the flat surfaces. The core material is preferably an expanded polyurethane foam material. A building structure is constructed from such panels used as exterior and interior wall panels, floor panels and roof panels.

### CROSS-REFERENCE TO RELATED APPLICATIONS

This application is a continuation-in-part of U.S. application Ser. No. 11/286,307 entitled “STRUCTURAL INSULATED PANEL CONSTRUCTION FOR BUILDING STRUCTURES”, filed on Nov. 22, 2005.

### FIELD OF THE INVENTION

The present invention relates to a structural insulated laminated construction panel for the construction of building structures.

### BACKGROUND OF THE INVENTION

Building structures have been known for many years and wherein they are constructed using prefabricated panels which are assembled and interconnected on site to construct a building, such as a residential or commercial building. Some building structures utilizing panels have several disadvantages in that most of these panels are constructed with conventional building materials fabricated from wood or metal and this results in panels which are heavy and difficult to manipulate and therefore heavy machinery is required for the manipulation and installation thereof. Although such panels may be of high strength, they have further disadvantages in that they are not waterproof or mold-proof, they do not provide adequate insulation and are not very resistant to hurricane force winds. They are also expensive to fabricate and the erection thereof is relatively slow due to the fact that these panels are of a small size and are labor intensive to install. Concrete panels also have the same disadvantages and are expensive to transport. Therefore, there exists a need to provide construction panels which overcome these disadvantages.

U.S. Pat. No. 7,429,305 discloses a prior technique used to overcome the above drawbacks providing thermoplastic skins being adhered to foam insulation panels. The process and machine as disclosed in that patent make lightweight thermoplastic composite panels. These panels, however, through the use of adhesives and other flammable materials prevent their use as interior walls.

There is therefore a need for a structural insulated panel that is both fire resistant and lightweight.

### SUMMARY OF THE INVENTION

It is therefore a feature of the present disclosure to provide a structural insulated laminated construction panel for the construction of building structures which overcome the problems of the prior art as mentioned hereinabove.

Another feature of the present disclosure is to provide a structural insulated laminated construction panel for building structures and wherein the panels are of a high strength, water-proof, mold-proof, highly insulated, lightweight, fire-resistant, easy to assemble, high resistant to wind force, high impact resistant and which may be used for the construction of permanent residential structures or emergency structures wherein structures can be erected quickly and at low cost.

According to the above features, from a broad aspect, the present disclosure provides a structural insulated laminated construction panel for building structures and wherein the panel comprises a rigid core material layer of expanded polymeric material having opposed flat parallel surfaces. The expanded polymeric material is preferably cast in-situ between spaced fire-resistant inner and outer skins of pre-consolidated fiber sheets.

In another broad aspect of the preset disclosure, the structural insulated laminated construction panel is provided with connection means secured to at least one of the outer edges thereof and formed by an elongated composite fiber-reinforced polymer material channel to provide connection to the panel.

According to a still further broad aspect of the present disclosure these panels may be constructed of any desired length and of a width and a thickness of from about 2 inches to 9 inches.

According to a still further broad aspect of the present disclosure the core material is expanded polyurethane and the density of the core material is of about 2 lbs/cubic foot for a two inch thick core.

According to a still further broad aspect of the present disclosure the skin materials are formed from a fire resistant composite sheet of a rock or mineral based fiber consolidated within a binder material.

### BRIEF DESCRIPTION OF THE DRAWINGS

A preferred embodiment of the present invention will now be described with reference to the accompanying drawings in which:

FIG. 1 is a cross-section view of a structural insulated laminated construction panel of the present disclosure;

FIG. 2 is an exploded view, partly fragmented, showing the lamination of the structural panel;

FIG. 3 is an exploded view of a fragmented portion of the panel showing an electrical conduit or chase formed in the core of the panel;

FIG. 4 is a perspective view showing an in-line panel connection where opposed side edges of two panels are interconnected together;

FIG. 5 is a simplified section view showing two panels interconnected by the method of FIG. 4;

FIG. 6 is a perspective view showing another embodiment of how two panels are interconnected together with a straight rectangular channel interposed in the interconnection joint for use as an electrical or plumbing conduit;

FIG. 7 is a simplified section view showing the interconnection of FIG. 6;

FIG. 8 is a fragmented side view showing a panel of the present disclosure used as an exterior wall panel secured to a foundation sill and wherein the panel has a rectangular channel secured to a lower edge thereof;

FIG. 9 shows the construction panel used as a floor panel and wherein two panels are shown interconnected to a steel I-beam;

FIG. 10 is a side view showing a floor panel of the present disclosure supported over a steel I-beam and secured thereto;

FIG. 11 is a fragmented side view showing the construction panel of the present disclosure used as a floor panel and also as an exterior wall panel and both interconnected to a foundation sill plate;

FIG. 12 is a fragmented side view showing an exterior wall panel constructed in accordance with the present disclosure and connected on top of a floor attached to joists and interconnected to the sill plate through the floor and joists;

FIG. 13 is a fragmented perspective view illustrating how the plastics rectangular channel is connected to a floor surface;

FIG. 14 is a fragmented cross-section view illustrating the attachment of the rectangular channel to the floor surface;

FIG. 15 is a fragmented section view showing the construction panel of the present disclosure used as an upper exterior wall panel and connected on top of a lower exterior construction panel through a channel and an extension of a floor board of a second floor;

FIG. 16 is a perspective view of a joist hanger of a type well known in the prior art and utilized in the assembly of FIG. 15;

FIG. 17 is an enlarged cross-section view showing the interconnection of the two exterior vertical wall panels as illustrated in FIG. 15;

FIG. 18 is a fragmented section view showing two exterior vertical wall panels with a first floor joist structure therebetween and wherein these are interconnected together by composite fiber-reinforced polymer channels embedded in the end edges of the panels and an outer fiber-reinforced thermoplastic connection plate and inner right angle connectors;

FIG. 19 is a fragmented section view showing two exterior construction panels of the present disclosure connected to a conventional floor joist structure of a first floor;

FIG. 20 is a fragmented perspective view showing a gable wall constructed with the construction panel of the present disclosure and with the composite fiber-reinforced polymer channels being used as a cap for the gable wall and a support for flooring and ceiling sheeting material;

FIG. 21 is a fragmented section view showing the construction panels of the present disclosure being used as roof panels and exterior wall panels having a bevel composite fiber-reinforced polymer channel in a top edge thereof to support and attach the roof panel thereto;

FIG. 22 is a fragmented perspective view showing roof panels constructed in accordance with the present disclosure and secured to the exterior wall of FIG. 21 and to a gable end wall;

FIG. 23 is a top cross-section view, partly fragmented, showing a first embodiment of a corner connection using reinforced angle connectors and an embedded hollow column of plastics or composite materials;

FIG. 24 is a view similar to FIG. 23 but showing two exterior vertical wall panels interconnected together at a corner in an overlap configuration;

FIG. 25 is a view similar to FIGS. 23 and 24 but showing two exterior vertical panels provided with vertical mitered end edges and embedded reinforced angle connectors which are not visible from outside or inside the building structure when the panels are connected together at their mitered edges;

FIG. 26 is a fragmented perspective view showing a window opening formed in a vertical wall panel with a composite fiber-reinforced polymer material channel secured about the opening;

FIG. 27 is a fragmented perspective view showing a vertical wall panel constructed in accordance with the present disclosure and wherein the opening is reinforced by a thermoplastic header and reinforced thermoplastic studs on either side of the opening and wherein a composite fiber-reinforced polymer material channel is secured about the opening in a manner similar to FIG. 26; and

FIG. 28 is a side view, partly fragmented, illustrating the construction of a seismic anchor device capable of being attached to a support beam to which are connected the floor panels, wall and roof panels through the various connectors whereby to construct a paneled building structure which is substantially hurricane and earthquake proof.

### DETAILED DESCRIPTION OF THE INVENTION

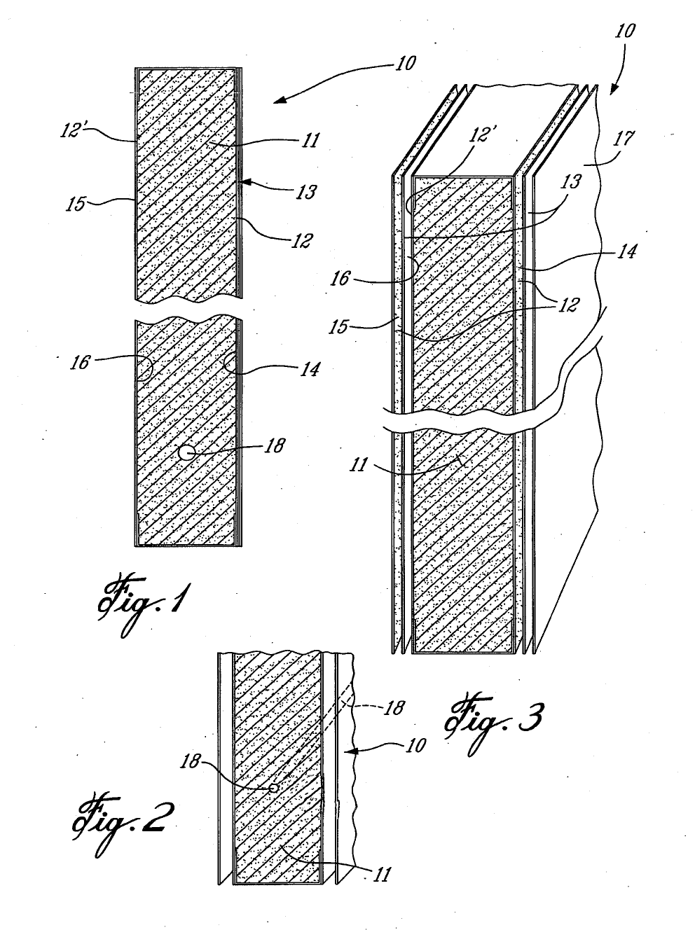

Referring now to the drawings and more particularly to FIGS. 1 to 3, there is shown generally at 10 a structural laminated construction panel for building structures and constructed in accordance with the present disclosure. The panel comprises a rigid core 11 of expanded polymeric material bonded to opposed pre-consolidated skin layers 13 and 15. Core 11 is preferably, but not exclusively, a fire-resistant expanded polyurethane material and which defines opposed flat parallel surfaces 12 and 12′ when cured within the layers 13, 15. In one non-limiting example, a core 11 has a density of about 2 lbs/cubic foot and excellent insulating properties.

A continuous outer skin 13 is secured to the outer surface 12 by the adhesive characteristics of the core material prior to and during curing, resulting in the cured core 11 being permanently bonded to the outer surface 12. The outer skin 13 is, in the preferred embodiment, a fiber-reinforced composite sheet and this provides for the attachment of surfacing tiles, concrete polymer, exterior paint and siding by the use of screw fasteners. In one embodiment, skin 13 includes a rock or mineral based fire-resistant fiber, such as a continuous basalt fiber material. In one embodiment, a paint-ready veil 17 may be applied to the outer skin 13, as shown in FIG. 2, to accept paint or elastomeric roofing material if the panel is being utilized as a roof panel or wall panel.

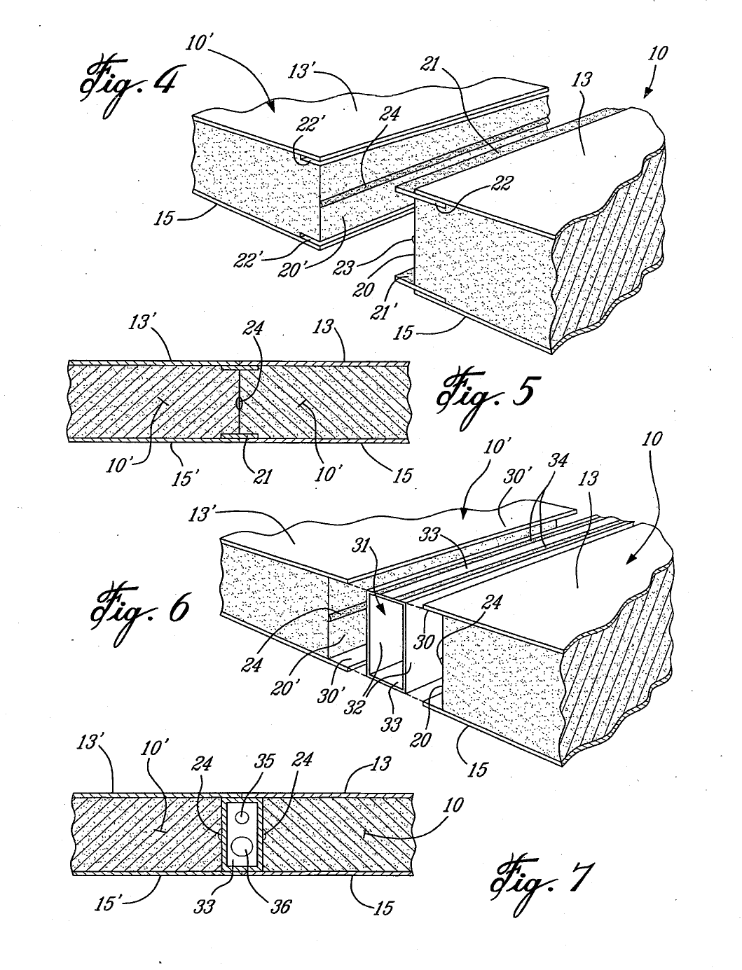

An inner skin 15 is similarly bonded to the inner surface 12′ during the curing process. Skin 15, like skin 13, preferably has a fire-resistant rating through the use of the fire-resistant rock-based fibers, thereby obviating the need for an additional layer of fire-rated material added to it (e.g., a layer of drywall). During assembly, each skin 13, 15 is preferably placed in a spaced parallel arrangement, with any chases or plumbing 18 prepositioned between the skins 13, 15 prior to injection of the uncured liquid or foam core material 11. As shown in FIG. 3, the core material 11 flows around the chases 18 and then secures the chases upon curing to provide for wiring or plumbing in such panels, being vertical wall panels or floor panels.

In the preferred embodiment, the construction panel 10 of the present disclosure is laminated in a continuous process and accordingly can have any length. Also, the width of the panel can vary and the thickness of the core material can be in the range of from about 2 inches to 9 inches.

Referring now to FIGS. 4 and 5, there are shown two construction panels 10 and 10′ constructed in accordance with the present disclosure and interconnected together along opposed straight flat connecting end edges 20 and 20′ respectively. One of the panels, herein panel 10, is provided with an elongated projecting tongue element 21, of fiber-reinforced FRP plastics or other suitable similar material, secured in an elongated slot 22 cut in the core material by a hot knife or other tool, and immediately behind the outer and inner skins 13 and 15 and retained therein by a structural adhesive suitable to weld fiber-reinforced plastics to fuse the tongue element 21 with the inner and outer skins. The elongated projecting tongue 21 projects outwardly of the end edge 20.

As hereinshown the other end edge 20′ is also provided with slots 22′ formed adjacent its outer skin 13′ and inner skin 15′ and these slots 22′ receive the extension portion 21′ of the tongues 21. A similar structural adhesive is disposed in the slots 22′. As also hereinshown, the end edges 20 and 20′ are provided with an elongated slot 23 routed therein whereby to receive a bead of flexible sealant material 24 to provide a thermally insulated structural sealed interconnection when attached together as illustrated in FIG. 5. As hereinshown, when the connection is made, the tongues are not visible from the exterior wall surfaces with the exception that a partition line will be visible between the adjacent outer and inner skins.

Referring now to FIGS. 6 and 7, there is shown a further interconnection of two adjacent vertical wall panels constructed in accordance with the present disclosure. In this particular embodiment, the inner and outer skins 13 and 15 of each of the panels are formed with a projecting connecting end portion 30 and 30′, respectively, of both of these panels 10 and 10′ and extending beyond the flat connecting end edges 20 and 20′ thereof, respectively. A straight rectangular fiber-reinforced plastic tube 31 is dimensioned for close fit between the flat connecting end edges 20 and 20′ of these two panels and is provided with opposed flat end walls 32 which are disposed flush under the projecting connecting end portions 30 and 30′ and in abutment with the flat connecting end edges 20 and 20′, as illustrated in FIG. 7. A structural adhesive as above-described is used for securing the projecting connecting end portions to respective ones of the opposed flat end walls 33 of the tube 31 and this adhesive is designated by reference numeral 34 wherein two beads thereof are disposed longitudinally over these end walls 33.

The adhesive 34 is a two-part adhesive consisting of a polyurethane liquid and/or an epoxy and is fabricated by the 3M Corporation under the trade mark Scotch-Weld. It is an adhesive that can bond many low surface energy plastics including many grades of polypropylene, polyethylene and TPOs without special surface preparation. It also sets at room temperature. The tube 31 thus forms part of the wall structure and can be used as an electrical and/or plumbing conduit in which is disposed piping 36 or wires 35, as shown in FIG. 7. The tube 31 also provides load bearing quality to the panel for concentrated loads from above. It is also pointed out that the cavities formed under the projecting end portions of the inner and outer skins may be formed by simply routing out the core material a depth which is approximately half the width of the channel 33 and therefore the extensions 30 and 30′ need not be formed during lamination of the panel. The flexible sealant 24 can also be applied directly on the flat connecting end edges 20 and 20′ of the two panels 10 and 10′ to provide a good thermal seal therebetween.

Referring now to FIG. 8, there is shown a conventional floor system bearing directly on a sill plate 40 secured to a foundation wall 41 projecting from a ground surface 42. This drawing illustrates an exterior wall panel 10 constructed in accordance with the present disclosure connected to the sill plate 40 and providing continuity of insulation and seal around the perimeter of a building structure supported on the foundation wall. As hereinshown, the rectangular exterior wall panel 10 is routed along its bottom flat edge surface whereby the outer skin 13 projects along a lower edge 13′ thereof and extends over a side wall 43 of an elongated rectangular tube 44 constructed of fiber-reinforced plastics FRP material and secured to the sill plate 40 by a bolt 45 or other suitable fastener anchored in the concrete foundation. The elongated rectangular tube 44 has opposed top and bottom parallel flat walls 46 and 46′ and opposed parallel end walls 47 and 47′. The lower flat edge surface of the panel 10 rests on the flat top wall 46 of the tube 44 with the projecting connecting end portion 13′ of the outer skin extending over the exterior end wall 47 of the tube and secured thereto by a fastening means which includes fasteners such as screw or rivet fasteners 49 and structural adhesive disposed over the top wall 46 and opposed outer end wall 47 of the tube member. This adhesive is disposed thereon prior to setting the panel over the tube after the tube is secured to the sill plate by the fastener 45. This structural adhesive is of the type as described hereinabove which is suitable to weld olefin-based plastics.

As also shown in FIG. 8, floor joists 50 are supported on the sill plate 40 and about the inner surface or inner skin 15 of the vertical wall panel 10. Each of the joists 50 are provided at a free end 51 thereof with a connecting plate 52 of a type well known in the art and by the use of fasteners 53 the joists 50 are connected to the vertical structural panel 10 and to the sill plate 40. Accordingly, it can be seen that the vertical wall panel 10 is rigidly anchored to the sill plate 40 and into the foundation and as well to the floor joists 50. A floor covering 54, such as plywood sheeting, is secured over the floor joist and adapted to receive thereover a finishing floor material such as hardwood, carpeting, tiles, etc.

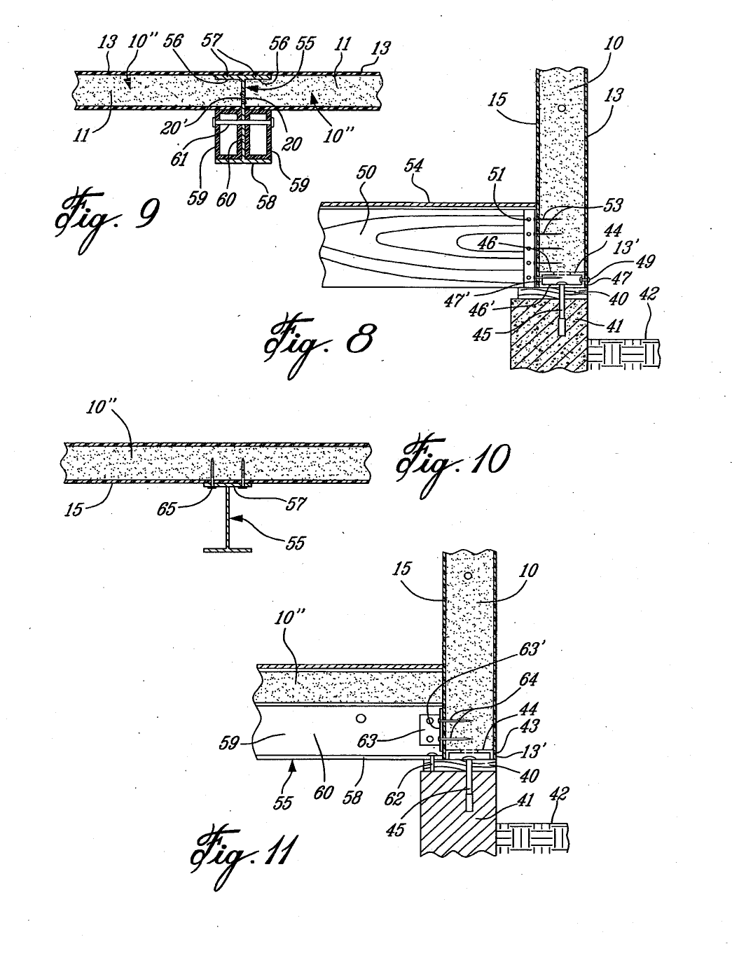

Referring now to FIG. 9, there is shown the structural insulated and laminated construction panel 10 of the present disclosure as used as a floor panel 10″. There are shown herein two of these floor panels 10″ secured to an I-beam 55. To secure the panels 10″ to the I-beam, a slot 56 is routed or preformed into the core material 11 of these two floor panels adjacent the end walls 20 and 20′ thereof and immediately under the outer skin 13 of the floor panels. These slots 56 are dimensioned to receive a top flange section 57 of the steel I-beam 55 which herein constitutes a support beam. Each of the floor panels 10″ rests on the bottom flange 58 of the I-beam through support blocks 59. There is hereinshown a support block 59 secured to each side of the web 60 of the I-beam and they rest on the flange sections of the flange 58 and connected thereto by a transverse connector 61. These support blocks are hereinshown as elongated hollow fiber-reinforced plastic tubes 59 of rectangular cross section and also serving as conduits for wiring and/or plumbing.

As shown in FIG. 11, one free end of the I-beam 55 has its bottom flange 58 resting on the sill plate 40 and secured thereto by a fastener 62 extending through the flange 58. An angled plate 63 is also secured to the web 60 of the I-beam and has its right angle flange 63′ connected to the inner skin 15 of the outer vertical wall panel 10 by fastener 64. A seismic or hurricane anchoring system may also be secured to the I-beam as will be described later.

The wooden floor joist structure as shown in FIG. 8 is usually spaced at the standard 24 inch maximum spacing whereas with the I-beams the spacing therebetween can extend up to 4 feet. Under the floor joist and the foundation wall there may be provided a full basement or a crawl space and this is obvious to a person skilled in the art. It is also pointed out that the structural adhesive as above referred to is also inserted in the slots 56 which connect to the top flange of the I-beam to secure them in the slots and this welds the two materials together. The size of the I-beam 55 is selected depending on the span and the load conditions required for 4 feet maximum spacing between these types of support beams.

Referring now to FIG. 10 there is shown another example of how a floor panel 10″ may be connected to the I-beam 55. As hereinshown, the I-beam is simply secured to the panel through its inner skin 15 by fasteners 65. Again, a structural adhesive may be disposed over the top face of the top flange 57 of the I-beam.

Referring now to FIG. 12, there is shown another embodiment of an exterior wall configuration where the floor joist 50 rests directly and over the sill plate 40 of the foundation wall 41. The outer wall construction panel 10 is constructed as previously described with reference to FIG. 8 and an elongated rectangular hollow fiber-reinforced plastic tube 44 is connected along the lower edge surface 48 thereof. As hereinshown this tube 44 is secured directly on the outer sheeting 54 of a plywood floor sheet secured over the floor joist 50 and extending to the outer end of the floor joist and the outer rim board 67. An insulation 68 is disposed over the back face of this rim board and between the joists as is conventional in building construction.

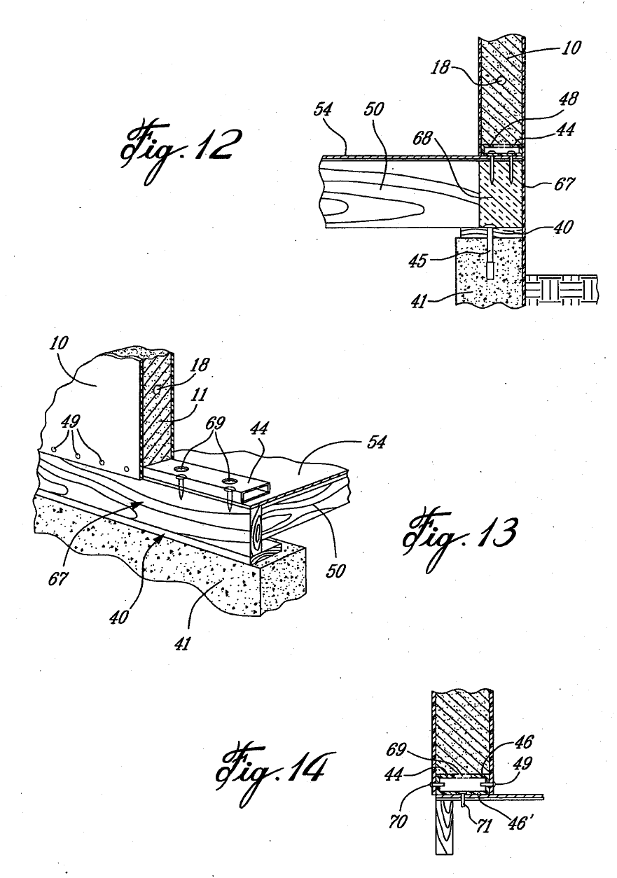

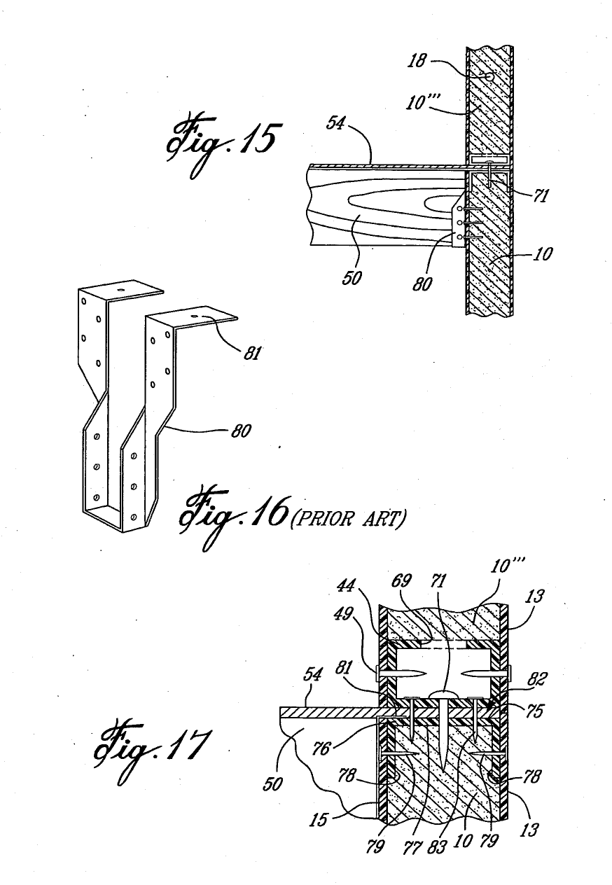

As shown in FIGS. 13 and 14, this elongated fiber-reinforced plastic tube 44 is provided with a plurality of aligned holes 69 and 70 formed in the top and bottom walls 46 and 46′ thereof. The hole 69 in the top wall is larger to provide access to the holes 46 in the bottom wall where fasteners are disposed, such as the fasteners 71 as shown in FIG. 14. Accordingly, these fasteners 71 do not interfere with piping or wiring that may be disposed within these hollow tubes 44.

Referring now to FIGS. 15 to 17, there is shown an example for the construction of a two-story building wherein there are two exterior wall panels 10 and 10′″ disposed in alignment one on top of the other and interconnected together. The lower vertical exterior wall panel 10 is herein provided along a top edge 75 thereof with an elongated composite fiber-reinforced polymer (FRP) channel 76. This channel has a flat bridge wall 77 and opposed parallel depending connecting arms 78 as clearly illustrated in FIG. 17. The top edge 75 of the lower wall panel 10 is routed or pre-formed to form a cavity therein to receive this FRP reinforcing channel therein. This channel is again secured along the top edge of the lower panel by the structural adhesive as previously described. Fasteners 79, such as screws or rivets, may also be inserted along the projecting edges of the outer and inner skins 13 and 15, as hereinshown.

The floor sheeting 54, secured to the joists 50, extends over the top edge 75 of the lower panel 10 and over the flanges 81 of the hanger connector 80 illustrated in FIG. 16 and used to support the joist 50 and forms a floor sheeting connecting extension 82. Before the upper wall panels 10′″ are secured over the bottom exterior wall panels 10, the flooring 54 is completed to the outer edge of the bottom panel to form this connecting extension portion. The connecting extension portion 82 is secured to the bridge wall 77 by adhesive and further fasteners 83 extending into the reinforced top edge of the lower panel 10.

The top outer vertical walls 10′″ forming a second floor, can now be installed. To do this installation it is first necessary to secure the elongated rectangular fiber-reinforced plastic tubes 44 over the connecting extension floor portion 82 by means of the fasteners 71 as previously described. The routed lower edge of the top panel 10′″ is then positioned over the channel and secured thereto by the fasteners 49 and the structural adhesive as previously described.

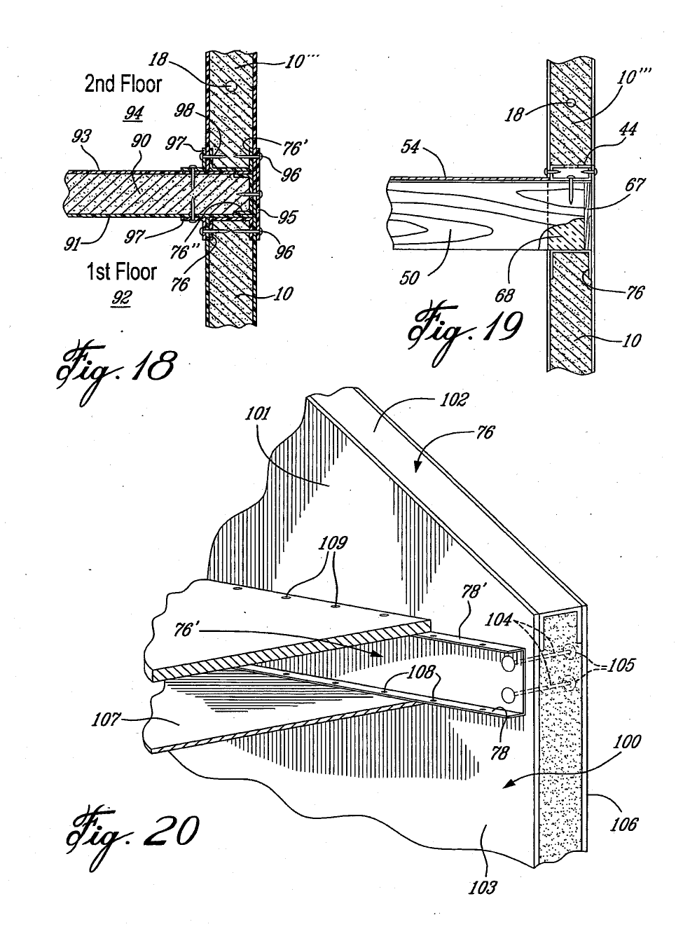

Referring now to FIG. 18, there is shown the construction panel of the present disclosure used as a floor panel 90 interposed between two vertical outer wall panels constructed in accordance with the present disclosure. All of these panels are provided with an elongated composite fiber-reinforced polymer channel 76 as previously described and these are shown at 76 and 76′ for the vertical wall panels 10 and 10′″, respectively, and at 76″ for the horizontal floor panel 90. Such a panel arrangement provides good insulation and sound barrier at the intersection of the walls and floor panels. The thickness of the floor panel 90 and the size of the embedded FRP channels is relative to the molding conditions and the span of the floor panel 90. The floor panel 90 forms a ceiling 91 on a lower side thereof for a first floor area 92 and forms a floor support surface 93 on the top side thereof for a second floor area 94. The skins applied to these panels suit the condition of their use wherein the lower surface 91 would most likely be applied a paint and the upper surface will be applied a floor covering.

A fiber-reinforced plastic elongated connecting plate 95 is disposed exteriorly of the exterior walls 10 and 10′″ and the outer edge of the floor panel 90 and spans this outer edge area, as hereinshown. This fiber-reinforced plastic plate 95 is secured to the FRP channels by fasteners 96 and structural adhesive of the type as previously described. On the inside of the building structure elongated angle brackets 97 are secured between the floor panel and the vertical walls and these are also formed of fiber-reinforced thermoplastic material. Again, fasteners 98 and the structural adhesive is used to effect this interconnection. Accordingly, it can be seen that the two vertical wall panels 10 and 10′″ and the horizontal floor panel 90 are rigidly and immovably secured together.

FIG. 19 depicts a platform frame method of a conventional floor construction comprising joists 50 resting on the upper end of the lower outer vertical wall panel 10. As hereinshown, the lower outer vertical wall panel 10 is provided with an FRP channel 76 embedded along its upper edge in a manner as previously described. This FRP channel is provided to receive fasteners from the rim board 67 and the joist 50. These fasteners are not shown herein but are obvious to a person skilled in the art.

A batt insulation 68 is disposed behind the rim board 67 and between the joists 50 to provide thermal insulation.

The floor joist 50 with its rim board 67 extends to the outer face of the lower vertical wall panel 10 and a fiber-reinforced plastic tube 44 is secured over the floor board 54 spanning the floor joist in: the same manner as previously described with reference to FIGS. 12 and 13 whereby to connect the upper outer vertical wall panel 10′″ thereto.

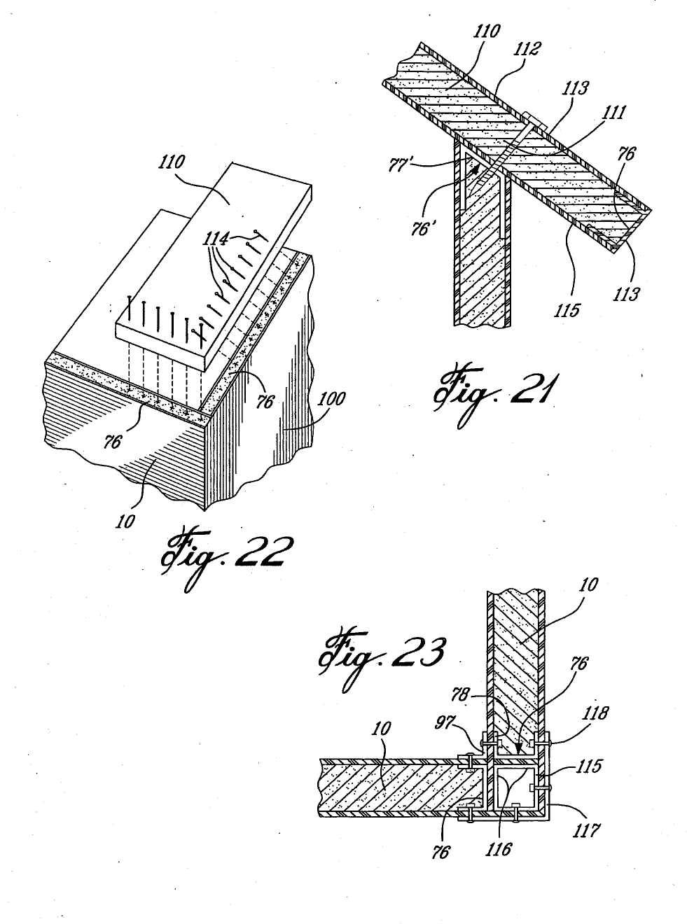

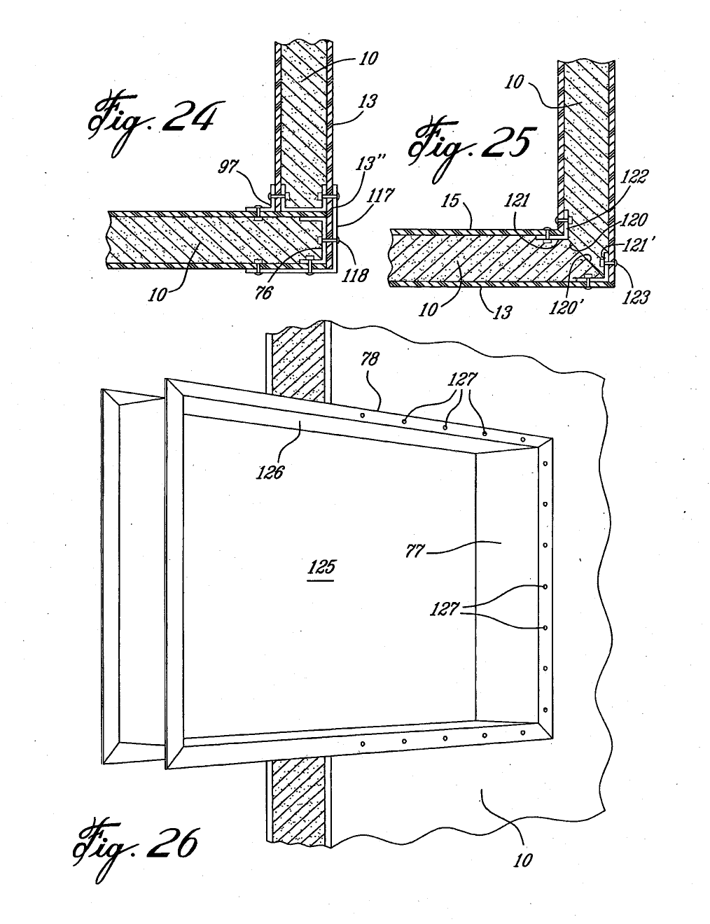

FIG. 20 illustrates an exterior wall panel 100 having a gable top end configuration as depicted by reference numeral 101. Again, an FRP channel 76 is embedded along the upper sloped outer edge 102 of the gable end portion 101. As also shown herein, an FRP channel 76′ may also be secured in a horizontal plane against an interior surface 103 of the structural panel constructed in accordance with the present disclosure, and herein panel 100. This FRP channel 76′ serves as a support for constructing a floor. The channel 76′ is secured by fasteners such as bolt fastener 104 and applied through the wall panel 100. The heads 105 of these bolts would be covered or hidden on the exterior wall 106 by the use of a trim board. Ceiling boards such as gypsum boards 107 could then be secured to the lower flange 78 by screw fasteners 108 and the upper floor sheeting 109 would be secured to the top flange 78′ of the channel 76′ also by the use of fasteners such as screw fasteners 109. Trusts, not shown could be supported therebetween.

Referring now to FIGS. 21 and 22, there are shown the panel of the present disclosure being used as a roof panel 110 having a rake and eave connection. For this application the FRP channel 76″ is provided with a bevel web 77′ disposed at an angle for the slope of the roofing panel 110. Bolt fasteners 111 would be disposed along the top surface 112 of the roof panel and extend into the web 77′ for connection thereto. Compressible washers may be used to seal the bolts to the outer skin to make them water-tight. To seal the outer edge of the roof panel 110 suitable capping 113 is applied whereby to conceal the FRP channel 76 embedded therein. Glue would be applied to the outer surface of the web 77′ prior to the installation of the panel to provide a secure bond with the inner skin 15. The outer skin 13 would be selected depending on the roofing material to be secured thereto.

FIG. 22 is a perspective view of a rake wall and gable wall connection. As hereinshown the roof panel 110 is secured along the FRP channel 76 of the gable wall 100 by the use of suitable fasteners 114 and to the FRP channel 76 of the right-angle outer vertical wall panel 10. Again, structural glue would be applied over these channels before setting the roof panel 110 thereon.

FIGS. 23 and 24 show three different variations of corner connections wherein the panels are interconnected at right angles to one another to form a corner of a building structure. As shown in FIG. 23, the exterior wall panels 10 are provided with FRP channels 76 embedded in their vertical outer edges thereof and a vertical column 115 constructed of fiber-reinforced plastics material is disposed in contact with the outer edges of the two panels 10 adjacent respective side walls 116 thereof. As hereinshown the column is a hollow column whereby to provide a conduit for piping or wiring. It could also receive insulation therein or anchors and concrete. Structural adhesive may also be provided between the column and the vertical edges of the panels.

To interconnect this corner column structure together, there is provided a large outer right angle connector 117 formed of FRP material and interconnected to some of the walls 116 of the column 115 and extending there beyond to connect to the right angle connecting arms or flanges 78 of the channel 76 by the use of fasteners 118. Again a structural adhesive is interposed on the inside of this exterior bracket. On the inside of the right angle corner panel structure a small elongated right angle bracket 97, as previously described, is connected to the panels and the right angle connecting arms 78 of the channel 76 in a manner as previously described.

FIG. 24 shows an arrangement wherein the end edge of an outer vertical panel 10 is disposed in abutment against a side edge of the other right angle panel 10. These panels are interconnected using the same right angle connectors 117 and 97 as described with reference to FIG. 23 and secured in the same manner. As hereinshown one of the panels may also be routed at an end portion thereof whereby to provide a skin extension 13″ which can extend over the FRP channel 76 of the other panel and interconnected thereto by glue and the fasteners 118.

Referring now to FIG. 25, there is shown another corner connection wherein the panels 10 have a mitered end edge 120 and 120′, respectively. These miters extend at a 45.degree. angle whereby when abutted with one another form a right angle corner. In this particular embodiment the panels are interconnected together in facial contact by two elongated right angle FRP internal connectors 121 and 121′ disposed in connecting slots 122 formed behind the inner and outer skins 13 and 15 in a manner as previously described and secured therein by the use of the structural glue. Structural glue is also applied along the mating mitered faces 120 and 120′. Accordingly, these connectors are concealed and cannot be seen from the exterior or interior of the building structure. Suitable fasteners 123 are used to further secure these panels together as shown.

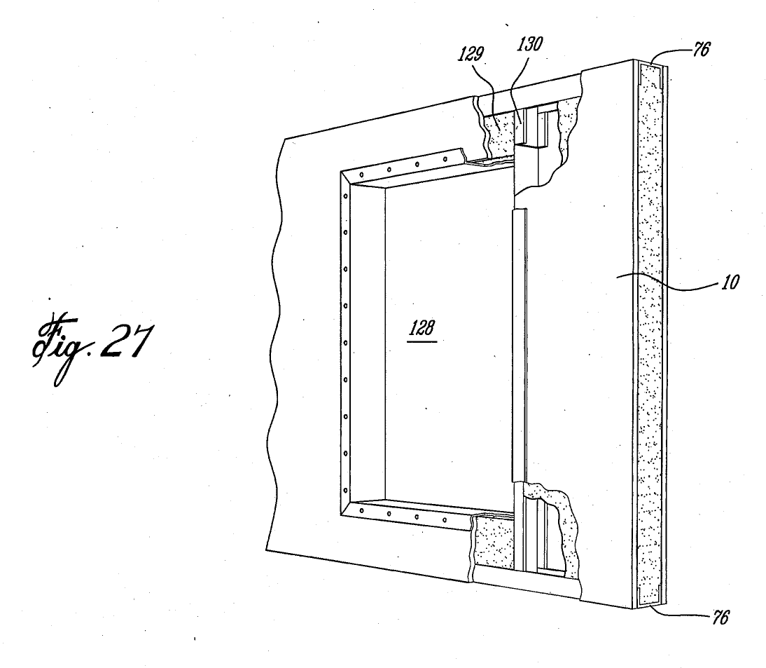

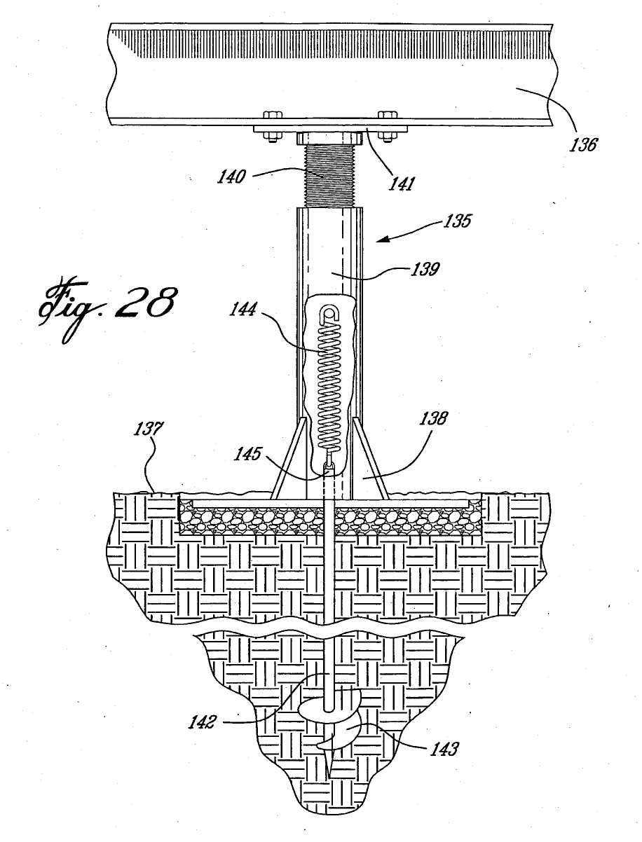

Referring now to FIGS. 26 and 27, there is shown vertical wall panels 10 in which window openings 125 are cut therein. An FRP channel 126 is secured within the opening and the bridge walls 78 thereof are secured to the outer and inner skins of the panel by the structural adhesive and fasteners 127 in a manner as previously described. The bridge wall 77 spans the entire width of the panel 10. As hereinshown, the opening forms a window opening and a window frame is then installed within the FRP channel frame 126 by using conventional fasteners and insulation material. These panels are manufactured with these FRP channels installed and therefore a building structure can be erected very quickly by simply connecting the panels together and then installing the windows into these prepared openings.

FIG. 27 shows a window or a door opening 128 which is reinforced with a thermoplastic header 129 and one or more composite fiber-reinforced studs 130 embedded into the panel 10 along opposed side edges of the opening 128. The header 129 is secured to an upper end of these reinforced studs 130. As hereinshown, the panel 10 is also provided with FRP channels 76 along the top edge and bottom edge thereof to provide interconnection with other panels or building materials.

Referring to FIG. 28, there is shown the construction of a seismic anchor device 135 which may be secured to one or more support beams 136 to anchor them into a bearing soil 137. This seismic anchor device comprises a support base 138 with a vertical cylinder 139 being secured thereto. An adjustable post 140 is threadably connected to the vertical cylinder 139 and provides adjustability. A connecting flange 141 is secured to the top end of the adjustable post 140 for connection to one or more support beams 136. An anchor rod 142 which is provided with a helical screw vane 143 is driven into the bearing soil at a predetermined depth to provide a secure anchor. Other form of anchoring means may be provided such as for anchoring in rock, or other soil compositions. A heavy-duty spring 144 is connected at a free end 145 of the rod 142 to provide a damping effect should there be an earthquake or should the building structure be subjected to hurricane forces. It is pointed out that all of the panels with their interconnections as described above are indirectly connected to the support beam or beams 136 and an entire building structure would be anchored by the use of one or more of these seismic anchors 135.

It is within the ambit of the present disclosure to cover any obvious modifications of the preferred embodiment as described herein and relating to the structural insulated and laminated construction panel 10 of the present disclosure provided these modifications fall within the scope of the appended claims. For example, various types of skins may be laminated on opposed sides of the core and these building panels can be constructed of different lengths and shapes depending on the architectural design of a building to be constructed thereby. The FRP channels can also vary in sizes depending on panel widths and lengths and thickness, may be provided with openings formed therein. The core material can also be fitted with various inserts before lamination provided these inserts can withstand the temperature of the laminating machine. Also, one can appreciate that because of the light weight of these panels an entire building structure can be erected with minimal labor cost and because of the ease of interconnecting these panels, it is not necessary to have high-skilled labor to construct a building structure. A single panel can form a complete exterior wall of a building structure. Also, such structures can be erected in very short time periods and are therefore suitable for the construction of temporary shelters and low-cost housing. The strength of these panels as well as their water-proof and mold-proof and good insulation make it attractive for the construction of building structures, either residential or commercial in hot climate areas and areas subjected to high winds and hurricanes. These panels are also resistant to high-impact forces such as flying building material and are relatively puncture-proof against such materials when projected thereagainst. It is also foreseeable that these panels can be used for the construction of foundations and basement floors.

What is claimed is:

1. A structural insulated laminated construction panel for building structures, said panel comprising:
a pair of spaced parallel skins which cooperate to define an internal void, each skin is substantially rigid comprising a rock-based fiber consolidated with a binder material; and
a core material layer of expanded polymeric material which is injected between the skins in a flowable form, substantially filling said void and then curing to a rigid state, wherein said core material layer is bonded to inward surfaces of both of said skins as said core material layer cures.

2. A structural insulated laminated construction panel as defined in claim 1, wherein said core material layer is expanded polyurethane.

3. A structural insulated laminated construction panel as defined in claim 2, wherein said rock-based fiber is a basalt fiber.

4. A structural insulated laminated construction panel as defined in claim 3, wherein said core material layer has a density of about 2 lbs/cubic foot.

5. A structural insulated laminated construction panel as defined in claim 2 wherein said rock-based fiber comprises a woven basalt fiber mat.

6. A method of forming a structural insulated laminated construction panel for building structures, said method comprising the steps of:
consolidating a fire resistant rock-based fiber material with a binder material to form a pair of rigid skins;
disposing said rigid skins in a spaced parallel relationship, whereby an internal void between the skins is formed;
injecting a flowable expanded polymeric material between said skins to substantially fill said void; and
curing said flowable expanded polymeric material to form a core material layer, wherein said core material layer is bonded to inward surfaces of both of said skins as said core material layer cures.
